(19) United States
(12) Patent Application Publication
(10) Pub. No.: US 2005/0242674 A1
(43) Pub. Date: Nov. 3, 2005

(54) Electromagnetic Induction in a Vacuum or Outer Space

(76) Inventor: Qin Chao Tan, Brooklyn, NY (US)

Correspondence Address: QIN CHAO TAN, 2248 84TH STREET, BROOKLYN, NY, 11214, US

(21) Appl. No.: 10/709,331

(22) Filed: Apr. 28, 2004

(51) Int. Cl. H02K 21/12

(52) U.S. Cl. 310/156.01

(57) ABSTRACT

The new art in which my invention pertains is that an electromagnet is placed within a vacuum. If the electromagnet was placed in a vacuum, it can move freely without friction. This is the main and most distinctive aspect from other inventions.

Many believed that all appliances that require electric power to function would only waste electricity. In other words, it still uses electricity even when it rarely used and saved. But is this thought fully correct? Are there any exceptions?

Proceed this experiment by preparing two congruent electromagnets (one for Motor and the other for the generator) and take one to test it out. If the case was that the input is 10 electrical current and the rate at which the motor run is 100, then connect the two electromagnets (Motor/Generator) and also input 10, it would spin at a rate about 50. Then place them in a vacuum. If the rate of the generator is above 100, then this project is successful. Please compare the numbers below. [image]
1) Motor−>input 10 electrical current−>spins at 100
2) Motor/generator−>input 10 electrical current−>spins at 50−>output 5 electrical current (lose 5)
3) Motor/generator−>input 10 electrical current−>spins at 150−>output 15 electrical current (gain 5) (In Vacuum)

According the example above, in order to gains more electrical current output, the spinning rates of Vacuum model (3) must be greater than it previous performance (1). The weigh of the motor's rotors is an important concept that directly affects the spinning rates.

| Motor in expose air | Motor/Generator in Vacuum | |
|---|---|---|
| 50 lb rotor > | 2 × 50 lb rotors > Input 10 > Spin 150 | −33% |
| Input 10 > Spin 200 | | |
| 100 lb rotor > | 2 × 100 lb rotors > Input 10 > Spin 150 | +50% |
| Input 10 > Spin 100 | | |
| 200 lb rotor > | 2 × 200 lb rotors > Input 10 > Spin 150 | +200% |
| Input 10 > Spin 50 | | |
| 420 ton rotor > | 2 × 420 ton rotors > Input 10 > Spin 150 | +??? % |
| Input 10 > Spin 0 | | |

* All these values, not actual value, are shown as an example to compare. The spin rates of the vacuum would have only slight amount changes because it don't have much of an affect, so we keep the rate values constant.

Base on the chart above, the heavier weights tend to spin less cause of the large amount of friction produced and the gravity attraction. But in a vacuum, that is a different case. Because the Motor/generator is in a vacuum, it does not matter the weight of a substance, the weight is still zero. Therefore friction is reduced. With less friction in a vacuum, the spinning rate will only slight changed. From this chart, using the Motor/generator that is in a vacuum (3) we can overcome the previous models (1). I believe that the motor and generator with the lack of both weight (gravity) and air resistance can run more efficiently and gain more electrical current instead of losing (more profitable). As the result, this project could be successful.

[image]

Now, continuing the experiment by cut the input of 10 electrical current and link to its own produced 15 electrical current. (Shown on the diagram on the bottom right) For example:

[image]

1. The essential theme of this invention is to create electromagnetic induction in a vacuum or outer space.

2. Any kind of electric power can be used as an electrical input.

3. With claims 1 and 2 as the main importance, any kind of further design of an electromagnet that may or may not apply to my invention would not be important.

4. Any size or shape of an electromagnet can be placed in a vacuum or outer space.

5. A series of electromagnet can be attached to increase the amount of electricity produced.

6. When the electromagnet is running, the electrical input can be removed, however the induction and the generation of electricity would still continue for a periods of time. (unpredictable)
